(19) United States
(12) Patent Application Publication
(10) Pub. No.: US 2026/0336515 A1
(43) Pub. Date: Oct. 29, 2026

(54) ACCESS REGION INDICATOR FOR AN ACCESSIBLE VEHICLE

(71) Applicant: The Braun Corporation, Winamac, IN (US)

(72) Inventors: Eric Sajed Dosenbach, Indianapolis, IN (US); Tyler Schultz, Carmel, IN (US)

(73) Assignee: The Braun Corporation, Winamac, IN (US)

(21) Appl. No.: 19/707,759

(22) Filed: Jun. 15, 2026

Related U.S. Application Data
(63) Continuation of application No. PCT/US2024/058435, filed on Dec. 4, 2024.
(60) Provisional application No. 63/610,168, filed on Dec. 14, 2023.

(51) Int. Cl. B60Q 1/50; B60Q 5/00

(52) U.S. Cl. CPC B60Q 1/544; B60Q 5/005

(57) ABSTRACT

An access region indicator for an accessible vehicle is provided. The access region indicator may comprise a light source that projects an indication light in at least a portion of the access area to alert passersby of the existence or need for the access area. The access region indicator may additionally include audible alerts, for example should a passerby remain or leave objects in the access area. The system may also embody a sensor, such as a camera, that detects objects approaching the vehicle and entering the access region adjacent the vehicle's accessible entry. The system may also include a computing system or controller that controls activation and deactivation of the access region indicators based on the status of the vehicle or perceived objects adjacent to the vehicle.

### CROSS REFERENCE TO OTHER APPLICATIONS

This application is a continuation of International Patent Application No. PCT/US24/58435 filed on Dec. 4, 2024, which claims priority to U.S. Provisional Patent Application No. 63/610,168 filed on Dec. 14, 2023, the contents of both being incorporated herein by reference. This application further incorporates by reference U.S. Provisional Patent Application No. 63/484,000, filed on Feb. 9, 2023.

### FIELD OF THE DISCLOSURE

The present disclosure relates generally to improving accessibility in an accessible vehicle by providing indications to other vehicles and persons of the existence, extent, and/or purpose of the access area adjacent the accessible vehicle that is needed for access device deployment and/or wheelchair maneuvering.

### BACKGROUND

This section introduces aspects that may help facilitate a better understanding of the disclosure. Accordingly, these statements are to be read in this light and are not to be understood as admissions about what is or is not prior art.

Accessible vehicles have designated parking spaces in public parking areas, specifically with access aisles on at least one side of the space to give the accessible vehicle adequate space to deploy an access device and ensure the access device user room to maneuver and enter or exit the vehicle using said device. These access aisles are typically marked off by a painted crosshatch pattern on the pavement, with no physical barrier to prevent another vehicle from entering the zone. Without a physical barrier, some drivers do not respect the law preventing parking in these access aisles and park their vehicle in this area. This can cause the access device user to not have sufficient space to deploy or access the wheelchair access device, forcing them to wait for the obstacle to clear.

An illegally parked car in the access aisle of a parking lot is easily identifiable by the operator of the access device, but there could exist other obstacles for the access device deployment not noticed by the operator if visibility is an issue, such as at night, or if the operator is not sufficiently attentive, or if parking in unfamiliar spaces like in a house driveway rather than in flat parking lots.

For scenarios such as these, it is crucial for a system to notify other drivers and passersby of the need for the access region adjacent the vehicle and/or to warn them to not leave their vehicle or other objects in that region. It may also be helpful for the system to notify an operator of an access device of a potential obstruction before the access device is deployed into the obstacle and causes damage to the access device or whatever obstacle it contacted. An obstruction could include humans or animals standing in the access device deployment area, so a notification system for obstructions would serve as a safety device as well.

Modern automotive technology has progressed to include many sensors that are standard on new vehicles sold or may be added as aftermarket accessories. These sensors can include, but are not limited to, cameras, Radar, Light Detection and Ranging (LiDAR), and Global Positioning System (GPS). These are used for parking, reversing, cross traffic detection, and blind spot detection. These sensors are typically used while the vehicle is in motion, for instance the backup sensors may only be activated when the car is in reverse. These sensors may not be active while the vehicle is parked. Since they are not functionally necessary for anything else when the vehicle is parked, these sensors can be accessed and used for detection of other vehicles or objects that may be approaching or are obstructing the access area while the car is parked.

Therefore, there is an unmet need for a system to project a light in the wheelchair access device deployment area and/or wheelchair maneuvering area. There is also an unmet need for using sensors that detect approaching vehicles or objects to activate the light. There is also an unmet need for detecting obstructions/hazards and alerting the operator of an access device, for example, by flashing or changing the color of the projecting light and/or generating an audible alert.

### SUMMARY OF THE EMBODIMENTS

In one embodiment, an accessible vehicle is provided that incorporates a light source that may indicate an access region needed for the vehicle. The light source may be positioned to illuminate the indicating light approximate the access entry of the vehicle. The access region may be roughly defined by the profile of the access device in the deployed position, or may include the stowed position of the access device if the access device stows into the floor space of the vehicle. The access region may be offset from the deployed position of the access device to allow adequate space for maneuvering around the access device. The access device may be a wheelchair ramp, a wheelchair lift, or other device capable of allowing a wheelchair to move from a surface at one elevation to a different surface at a different elevation, or a swivel seat or other device that allows a person with mobility disabilities easier access to the vehicle.

The light source may illuminate at least a portion of the access region with a geometric shape, a pattern, an image, color, a word or phrase, or a special effect. The word or phrase may be used to communicate the existence or purpose of the access region. The light source may project an image of a wheelchair symbol, similar to the symbol marking the designated accessible vehicle parking spaces.

The light source may be mounted to the vehicle, such as on a pillar or side-view mirror, or to the access device directly.

The light source may include a remote for a user to activate or deactivate the light source.

The light source may be activated or deactivated based on signals from a processor that may monitor one or more statuses of the vehicle such as PRNDL status, parking brake status, access door status, ignition status, or any other status that can be used to determine a safe operating condition of the access device.

The light source may be activated or deactivated based on signals from a processor that may monitor the surrounding conditions of the vehicle using at least one sensor such as cross-traffic sensor, reverse sensor, parking sensor, blind spot sensor, or any other sensor that monitors the space around a vehicle. The one or more sensors may be engaged based on the one or more vehicle statuses, such as if the vehicle is in park and ignition is off.

A computer-implemented method is provided comprising the steps of: monitoring whether an object is present in an access region based on input from one or more perception sensors; and if the object is determined to be present in the access region, notifying the person by a light source change indication and an audible beeping alarm.

The one or more perception sensors may comprise one or more of a camera sensor, a LiDAR sensor, a ToF sensor, a RADAR sensor, a EmDAR sensor, a SONAR sensor, a SODAR sensor, a GNSS sensor, an accelerometer sensor, a gyroscope sensor, an IMU sensor, an infrared sensor, a laser rangefinder sensor, an ultrasonic sensor, an infrasonic sensor, and a microphone.

The one or more perception sensors may be calibrated as to not detect the wheelchair access device itself as an obstacle in the deployment area.

The processor may gather position data from the access device and deactivate the indicting light if the access device is in the deployed position.

The audible beeping alarm may use the vehicle warning system to play the beeping alarm through the speakers similar to the lights-on alarm, or the car horn alarm.

The visual indication of an obstructions may be a command for the light source to blink, change color, change the word or phrase displayed, or any other special effect that is different from the standard light source indication of the access region when no obstruction is present.

The processor may include a timing device to deactivate the light source after a defined time of activation.

### BRIEF DESCRIPTION OF DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 and FIG. 2 illustrate an environment that includes: a light source projection system to illuminate and/or indicate the access area where a passenger enters an accessible vehicle using a deployed access device; and, an obstruction perception system that detects obstructions in that access area that may prevent an access device from moving uninhibited or prevent a wheelchair from maneuvering on and off of the wheelchair access device.

FIG. 3 illustrates the field of view from the obstruction perception system of FIGS. 1 and 2 when the access device is fully deployed.

FIG. 4 illustrates the field of view from the obstruction perception system of FIGS. 1 and 1 when the access device is moving and an obstruction has entered the path of the access device.

FIG. 5 illustrates the field of view from the obstruction perception system of FIGS. 1 and 2 when the access device is moving and an obstruction stays outside the path of the access device.

FIG. 6 illustrates the systems within a accessible vehicle that may be active during an obstruction detection process.

FIG. 7 illustrates a method for calibrating the obstruction perception system of FIGS. 1 and 2.

FIG. 8 illustrates a method of which the light source projection and audiovisual alarm system may be activated.

FIG. 9 illustrates a method of which the light source projection and audiovisual alarm system may be activated to notify other people while the accessible vehicle is parked.

FIG. 10 illustrates a method for the internal computing system to gather the position from the access device to determine when to send the obstruction alarm signals.

FIG. 11 illustrates an example indication light projected on the ground by the light source projection system of FIGS. 1-2 to notify passersby of the existence, extent, and purpose of an access region adjacent the access door opening.

Corresponding reference numerals are used to indicate corresponding parts throughout the several views.

It should be understood that the drawings are not necessarily to scale and that the embodiments are sometimes illustrated by graphic symbols, phantom lines, diagrammatic representations and fragmentary views. In certain instances, details which are not necessary for an understanding of the embodiments described and claimed herein or which render other details difficult to perceive may have been omitted. It should be understood, of course, that the inventions described herein are not necessarily limited to the particular embodiments illustrated. Indeed, it is expected that persons of ordinary skill in the art may devise a number of alternative configurations that are similar and equivalent to the embodiments shown and described herein without departing from the spirit and scope of the claims.

### DETAILED DESCRIPTION OF THE EMBODIMENTS

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure. Any alterations and further modifications in the described embodiments and any further applications of the principles of the inventions as described herein are contemplated as would normally occur to one skilled in the art. Although a limited number of embodiments are shown and described, it will be apparent to those skilled in the art that some features that are not relevant to the claimed inventions may not be shown for the sake of clarity.

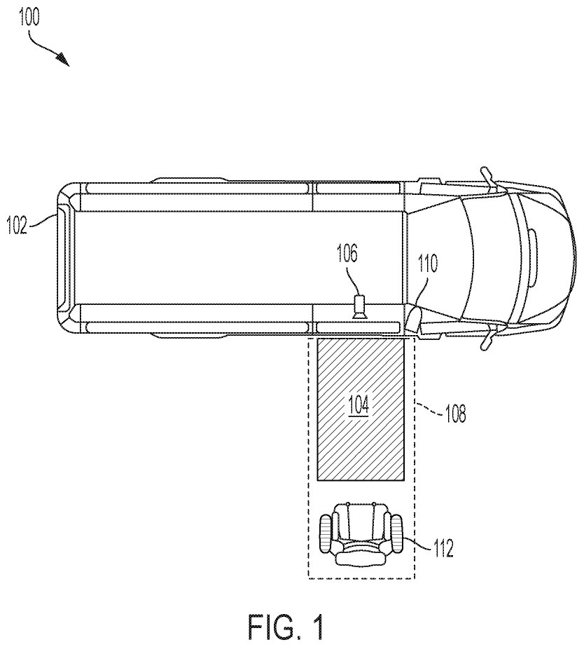

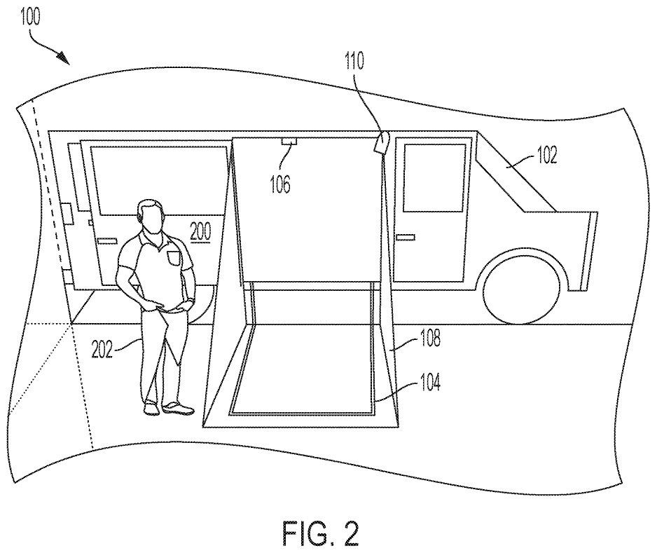

FIGS. 1, 2, and 11 illustrate an example environment 100 in which an accessible vehicle 102 may be provided with at least one light source (e.g., a light projector utilizing an LED, laser, lamp, fluorescent, incandescent, halogen, xenon, neon, argon, or other known light projection source) 110 that is configured to notify passersby of access region 108, for example, by projecting indication lights 1114 in, on, around, or near at least a portion of access region 108. Access region 108 may be defined as the area adjacent vehicle 102 that is needed for an access device 104 such as a wheelchair ramp or lift to move between its stowed and deployed positions and/or for a wheelchair 112 to maneuver in and out of the vehicle 102 (e.g., on and off the access device 104). In other embodiments, access device 104 in the form of a swivel seat or other assistive device that allows a person with mobility disabilities easier access to a vehicle seat.

The light source 110 may be coupled to a housing or lens configured to direct the indication lights 1114 roughly on, around, or near at least a portion of access region 108. The light source 110 may be powerful enough to meet the lumens requirement to be visible in daylight.

The light source 110 may be mounted internal to the cabin of the vehicle (e.g., in the ceiling, the opposite wall or door, or a pillar of the vehicle, etc.), external to the vehicle (e.g., above, to either side, or below the door opening, a side-view mirror, a vehicle pillar, etc.), or the access door 200. The light source 110 may be mounted to the frame in which the wheelchair access device 104 stows into.

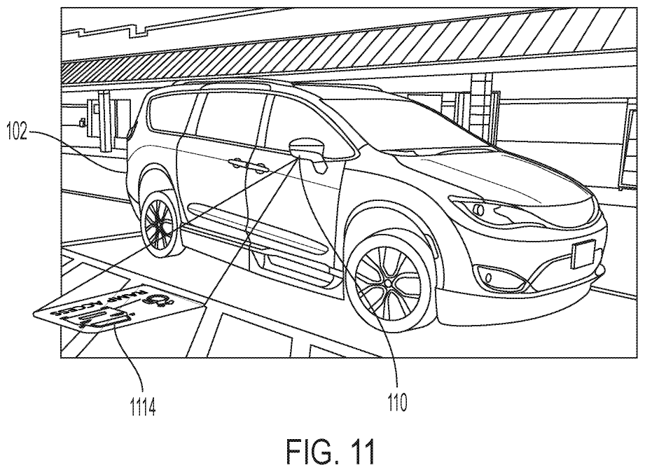

The indication lights 1114 projected by light source 110 may convey a message by its location on the ground and/or through geometric shapes, patterns, images, colors, words, flashing, etc. For instance, as shown in FIG. 11, the projected indication light 1114 may encompass an area on the ground generally corresponding to at least a portion of or substantially the entire access region 108, may have a rectangular shape corresponding to the shape of the access device 104 and/or access region 108, include an image of a wheelchair entering a wheelchair accessible vehicle, include the words “RAMP ACCESS”, and/or encompass at least a portion of the access region 108. In that respect, the projected indication lights 1114 may provide an indication of the existence, extent, need, and/or purpose of access region 108 to passersby and/or warn them not to obstruct the access region 108 with their body, vehicle, or other objects.

In some embodiments, the light source 110 may be manually activated/deactivated, for example by a hardwired switch (not shown) located on the light source 110 or elsewhere in vehicle 102. Additionally or alternatively, the light source 100 may be manually activated/deactivated using a wireless switch (not shown) such as a remote control button or touch screen on a personal handheld device that operatively communicates with a light source controller (not shown).

In some embodiments, the light source 110 may be activated/deactivated based on the status of the vehicle 102. For example, the light source 110 may be interconnected with and configured to activate when the access door 200 ajar sensor detects that access door is open, when the vehicle 102 PRNDL sensor detects that the vehicle is in park, when the vehicle 102 operation sensor detects that the vehicle is off, and/or when the vehicle 102 parking brake sensor detects that the parking brake is activated. In one embodiment, a relay (not shown) or equivalent may activate and deactivate the light source 110 based on those status signals from the vehicle 102.

In some embodiments, the light source 110 may be activated/deactivated based on various sensors on the vehicle 102, such as parking sensors (front obstruction sensors), reverse sensors (rear obstruction sensors), cross traffic sensors, blind spot sensors, or other sensors, that perceive areas surrounding the vehicle and can detect approaching vehicles, persons, and other objects. As with the previous embodiment, a relay (not shown) or equivalent may activate and deactivate the light source 110 based on those perception signals from the vehicle 102.

In some embodiments, the light source 110, when activated, may continuously project indication light 1114. In other embodiments, the light source 110, when activated, may illuminate periodically to conserve the vehicle 102 battery.

In some embodiments, the light source 110 may be interconnected with and activated/deactivated based on signals from accessories that detect potential obstructions as they approach the vehicle 102 and/or approach/enter/stay within the access region 108. Additionally or alternatively, the light source 110 may be interconnected with and activated/deactivated based on signals from accessories that detect obstacles that prevent access device 104 from moving uninhibited between a stowed position and a deployed position. The vehicle 102 may be provided with at least one perception sensor 106 that is positioned to perceive such obstructions.

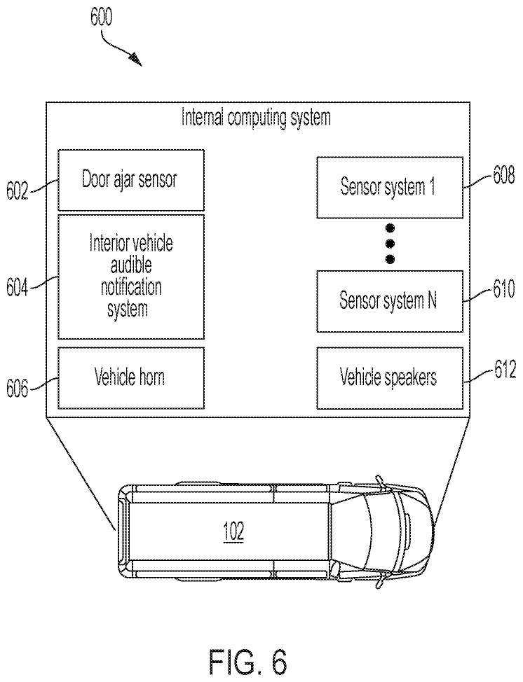

As shown in FIG. 6, the vehicle 102 may be provided with an internal computing system 600. The internal computing system 600 may be in communication and receive input from the perception sensor 106 (e.g., sensor system 608 or 610) and/or other sensors described above. The internal computing system 600 processor may execute instructions (e.g., machine learning software/algorithms) stored in the memory to receive and process the input, calibrate the system/identify thresholds/safety zones, determine whether obstructions exist, and/or take action as described in more detail above and below.

With reference to FIG. 6, the perception sensor 106 may take form as a single sensor 608 or multiple sensors 610 comprising one or more of any of the following: the camera sensor system, the Light Detection and Ranging sensor system (LIDAR), and the other exemplary sensor systems described in the Background section above (e.g., RADAR, EmDAR, SONAR, SODAR, GNSS, GPS, accelerometers, gyroscopes, IMU, infrared, laser, ultrasonic, infrasonic sensor systems, microphones, etc.) and a Time-of-Flight sensor (ToF). The perception sensor 106 may be mounted internal to the cabin of the vehicle (e.g., in the ceiling, the opposite wall or door, or a pillar of the vehicle, etc.), external to the vehicle (e.g., above, to either side, or below the access door opening, any side of the vehicle, etc.), or the access door 200. The perception sensor 106 may be mounted to the frame in which the wheelchair access device stows into. The perception sensor 106 may include a wide field of view and may be capable of monitoring not only at least a large fraction of the region occupied by the access device 104 in the deployed and/or stowed positions, but also adjacent regions, for example a wheelchair 112 maneuvering area, and possibly at least some portion of the area inside of the vehicle cabin, particularly if the access device 104 has a stowed position in the cabin above the vehicle floor. The perception sensor 106 may include one or more of commonly known sensors that monitor the front, rear, left and right sides of a vehicle, such as parking sensors (front obstruction sensors) or reversing (rear obstruction sensors), cross traffic detection, and blind spot detection.

The monitored area of access region 108 or other regions surrounding the vehicle 102 may be factory preset/pre-coded in the internal computing system 600 memory.

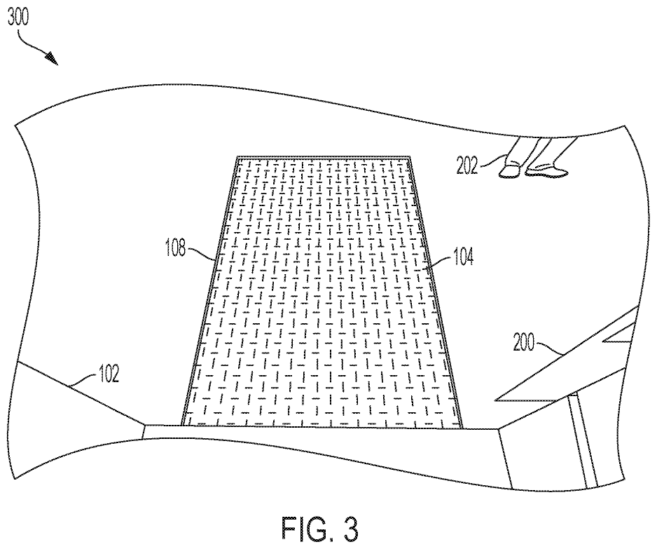

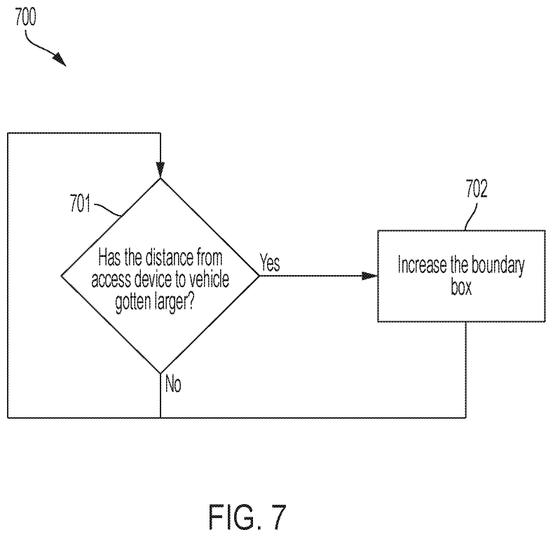

Additionally or alternatively, the internal computing system 600 may include artificial intelligence or other machine learning software/algorithms to automatically set, re-set, and/or calibrate the monitored area based upon actual perceptions from the perception sensor 106. In one embodiment, the monitored area may be set/reset/calibrated when the access device 104 is fully deployed, as best illustrated in FIG. 3 from the perception sensor's 106 point of view 300. Based on input from the perception sensor 106, the internal computing system 600 processor may identify the area occupied by the deployed access device 104 and create a boundary box around it (or modify an existing boundary box stored in memory). In one example, the internal computing system 600 will execute the logic 700 set forth in FIG. 7. In Step 701, the internal computing system 600 will evaluate input from the perception sensor 106 to determine if the distance from the access device 104 to the vehicle 102 (or alternatively, the area occupied by the access device 104) is larger than the distance currently stored in memory. If the internal computing system 600 detects an increase, the internal computing system will proceed to perform Step 702. In Step 702, the internal computing system 600 increases the boundary outline stored in memory and used in subsequent processes described herein.

The “boundary box” used to monitor the access region 108 may correspond to, closely correspond, or roughly correspond to the perceived perimeter of the access device 104. Alternatively, the boundary box may be simply based upon the perceived perimeter of the access device 104. For example, the boundary box may be enlarged along any one or more of the four sides of the access device 104 to provide a maneuvering zone around the access device 104. The size of the maneuvering zone may be pre-coded within the internal computing system 600 instructions, or can be customizable by the vehicle owner/operator or end user through any one or more of the vehicle inputs. In another embodiment (not shown), based on input from the perception sensor 106, the internal computing system 600 processor may identify the area occupied not only by the deployed access device 104 by also the area utilized by the wheelchair 112 to maneuver on or off access device 104 and create a boundary box around it (or modify an existing boundary box stored in memory).

Once the boundary box is set, the internal computing system 600 processor may evaluate input from the perception sensor 106 to detect the presence of obstructions in the access region 108. The internal computing system 600 processor may also evaluate input from the perception sensor 106 to detect the presence and/or movement of the access device 104.

In one implementation, the internal computing system 600 may be programmed to activate the light source 110 to project indication light 1114 on the ground in, around, or near the access region 108 when the access door 200 is opened.

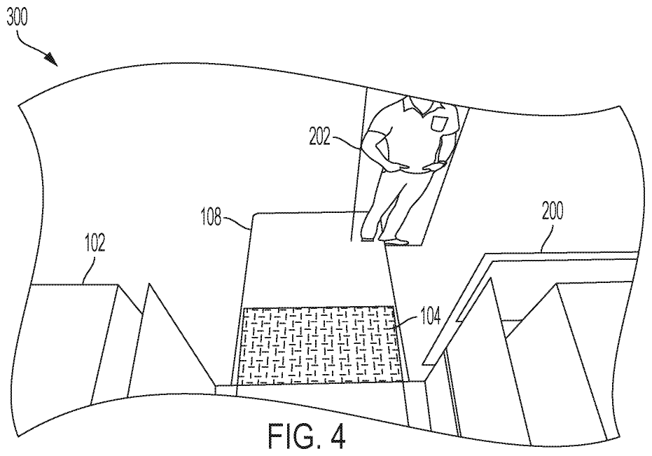

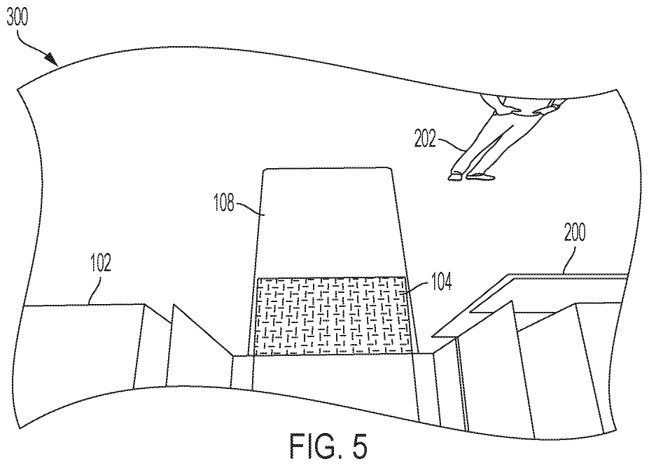

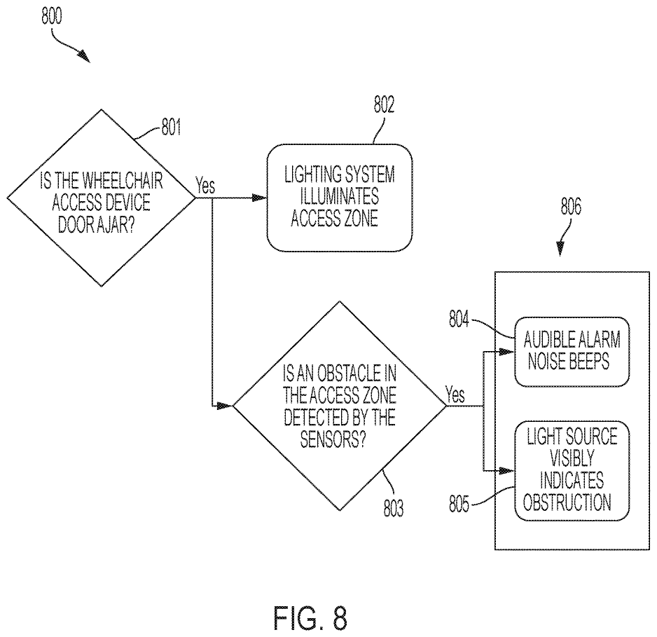

In another implementation, the internal computing system 600 may be programmed to notify the access device operator any time an obstruction is present in the access region 108 using the logic 800 in FIG. 8. Step 801 utilizes the vehicle door ajar sensor 602 to determine if the access door 200 is ajar. If yes, the internal computing system 600 may activate the light source 110 as in Step 802 and may activate the perception sensor 106 to scan the access region 108 as in Step 803. If the perception sensor 106 detects an obstruction in the access region 108, the internal computing system 600 may activate the preset alarm functions 806, which may include an audible noise as in Step 804 and a visual lighting change as in step 805. For instance, the internal computing system 600 may issue a command or signal to the vehicle audible notification system 604 or the vehicle horn 606. Additionally or alternatively, the internal computing system 600 may issue a command or signal to the light source 110 to change the output of the light source 110. The changed output of the light source 110 may be in the form of a blinking light, a change of color of the light, a focused and/or distinguishable region of light directed at or near the obstruction, or another form of indicating a difference between the standard indication light 1114 and a present obstruction. See, e.g., FIG. 4 which illustrates from the perception sensor's 106 point of view 300 that an obstruction 202 has entered the access region 108. In the case of FIG. 4, the internal computing system 600 would issue the command to the light source 110 and vehicle audible notification system 604 or the vehicle horn 606 to indicate there is an obstruction in the access region 108 using the user-programmed notification settings 806. Alternatively, the internal computing system 600 may by default issue an access device safe command or signal any time the access region 108 is clear of anything except for the access device 104 itself and cease issuing the access device safe command any time it determines that an obstruction is present in the access region 108. See, e.g., FIG. 5 which illustrates from the perception sensor's 106 point of view 300 that there are no obstructions in the access region 108; only the access device 104 is present in the access region. In the case of FIG. 5, the internal computing system 600 would issue the access device safe signal.

Additionally or alternatively, the internal computing system 600 may be coupled to the access device 104 position sensor to execute logic 1000 in which the internal computing system 600 may gather the access device 104 position in step 1001 and if the access device 104 is in the fully deployed position, the internal computing system will halt sending signals to the alarm system 806 as in step 1002.

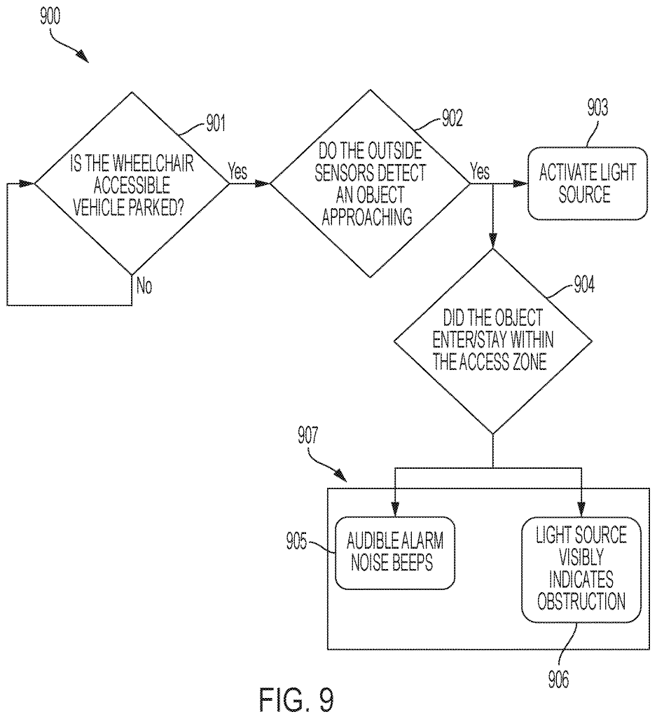

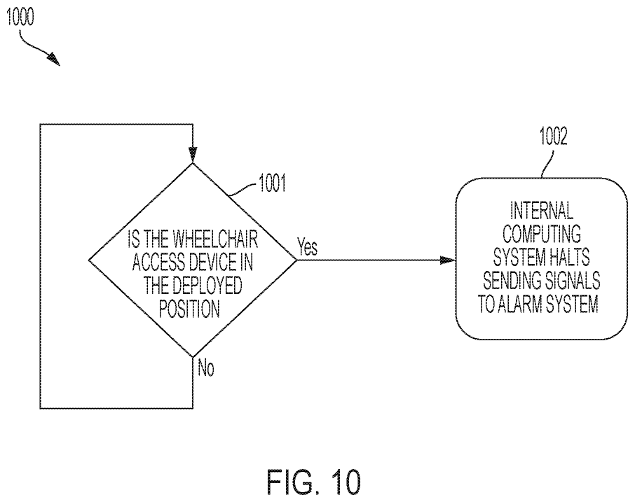

In another implementation, the light source 110 may notify other people as they approach or get close to the accessible vehicle 102. The one or more perception sensors 106 may include any one or more of the cross traffic-detection sensors, parking sensors, and reverse sensors when the accessible vehicle 102 is in park. The perception sensor 106 may detect an object, such as another vehicle, is approaching approximate to the accessible vehicle 102 and the internal computing system 600 may send a signal to turn on the light source 110 to illuminate the access region 108 with light indicator 1114 to notify the person of the existence, extent, and/or purpose of access region 108. In some embodiments, if the perception sensor 106 detects that an object has entered the access region 108, the internal computing system 600 may activate the preset alarm functions 907, which may include an audible noise as in Step 905 and a visual lighting change as in Step 906. The preset alarm functions in FIGS. 8-9 may be different based on the mode of object detection by the perception sensor 106. For example, in logic 800, if the access door 200 is ajar, the internal computing system 600 may conclude the operator is intending to move the access device 104, in which case the audible alarm 804 may be an interior vehicle audible notification system 604 played through the vehicle's speakers 612. Alternatively, in logic 900 if the perception sensor 106 detects the object approaching from outside the wheelchair accessible vehicle 102 and the access door 200 is closed, the internal computing system 600 may send the signal to activate audible alarm 905 using the vehicle horn 606 to play a beeping sound exterior to the vehicle.

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. An accessible vehicle comprising:
an accessible entry;
a light source configured to project an indication light onto an access region adjacent the accessible entry;
one or more sensors configured to perceive the access region; and
a controller operatively connected to the light source and the one or more sensors, the controller configured to:
determine that the vehicle is in an off state;
maintain the one or more sensors in an active state to monitor the access region while the vehicle is in the off state;
detect, via the active one or more sensors, an external vehicle approaching the access region; and
automatically activate the light source to project the indication light onto the access region in response to detecting the approaching external vehicle to warn the approaching external vehicle against obstruction of the access region.

2. The accessible vehicle of claim 1, wherein the controller is further configured to determine that an access door associated with the accessible entry is closed prior to maintaining the one or more sensors in the active state.

3. The accessible vehicle of claim 2, wherein the controller is further configured to determine that the access door is locked.

4. The accessible vehicle of claim 1, further comprising an audible warning device, wherein the controller is further configured to automatically activate the audible warning device to emit an audible alert exterior to the vehicle in response to detecting that the approaching external vehicle has entered the access region.

5. The accessible vehicle of claim 4, wherein the audible warning device comprises a vehicle horn.

6. The accessible vehicle of claim 1, wherein the controller is further configured to change at least one of a color and a flashing frequency of the projected indication light as a distance between the approaching external vehicle and the access region decreases.

7. The accessible vehicle of claim 1, wherein the controller is further configured to automatically deactivate the light source after a predetermined period of time via a timer.

8. The accessible vehicle of claim 1, wherein the one or more sensors comprise at least one of a camera sensor, a radar sensor, a LiDAR sensor, an ultrasonic sensor, and an infrared sensor.

9. The accessible vehicle of claim 1, wherein the indication light projected by the light source comprises a wheelchair symbol.

10. The accessible vehicle of claim 1, wherein the one or more sensors comprise one or more pre-existing OEM sensors of the vehicle, and the controller is a retrofitted controller operatively connected to interface with said one or more pre-existing OEM sensors.

11. A method of protecting an access region adjacent an accessible entry of an accessible vehicle, the method comprising:
determining, by a controller of the vehicle, that the vehicle is in an off state;
maintaining, by the controller, one or more vehicle-mounted sensors in an active state to monitor the access region adjacent the accessible entry while the vehicle is in the off state;
detecting, via the active one or more vehicle-mounted sensors, an external vehicle approaching the access region; and
automatically activating, by the controller, a vehicle-mounted light source to project an indication light onto the access region in response to detecting the approaching external vehicle to warn the approaching external vehicle against obstruction of the access region.

12. The method of claim 11, further comprising determining that an access door associated with the accessible entry is closed prior to maintaining the one or more vehicle-mounted sensors in the active state.

13. The method of claim 11, further comprising automatically activating a vehicle horn to emit an audible alert exterior to the vehicle in response to detecting that the approaching external vehicle has entered the access region.

14. The method of claim 11, further comprising changing an aspect of the projected indication light as the approaching external vehicle gets closer to the access region, wherein the aspect comprises at least one of a color, a pattern, a flashing effect, and a projected warning word.

15. The method of claim 11, further comprising deactivating the light source after a predetermined activation time has elapsed.

16. A method of converting a vehicle to actively protect an access region adjacent an accessible entry of the vehicle, the vehicle having one or more pre-existing sensors, the method comprising:
mounting a light source to the vehicle, the light source configured to project an indication light onto the access region; and
operatively connecting a controller to the light source and to the one or more pre-existing sensors of the vehicle;
wherein the controller is configured to:
determine that the vehicle is in an off state;
maintain the one or more pre-existing sensors in an active state to monitor the access region while the vehicle is in the off state;
detect, via the active one or more pre-existing sensors, an external vehicle approaching the access region; and
automatically activate the light source to project the indication light onto the access region in response to detecting the approaching external vehicle.

17. The method of claim 16, wherein the one or more pre-existing sensors comprise at least one of a pre-existing cross-traffic sensor, a pre-existing blind-spot sensor, a pre-existing parking sensor, and a pre-existing reverse sensor.

18. The method of claim 16, further comprising operatively connecting the controller to a pre-existing vehicle horn, wherein the controller is configured to automatically activate the pre-existing vehicle horn to sound an alert if the approaching external vehicle enters the access region while the vehicle is in the off state.

19. The method of claim 16, wherein the controller is further configured to verify that an access door associated with the accessible entry is closed prior to maintaining the one or more pre-existing sensors in the active state.

20. The method of claim 16, wherein the controller is further configured to automatically deactivate the light source after a defined period of time has elapsed.
